(19) United States
(12) Patent Application Publication
(10) Pub. No.: US 2012/0152839 A1
(43) Pub. Date: Jun. 21, 2012

(54) MODIFIED SULFONAMIDE POLYMERIC MATRICES

(76) Inventors: David Allen Olson, Minneapolis, MN (US); Qingshan Jason Niu, Excelsior, MN (US)

(21) Appl. No.: 12/973,144

(22) Filed: Dec. 20, 2010

(51) Int. Cl. B01D 71/56; B05D 3/10; B01D 61/02; C08G 75/00; B01D 61/10

(52) U.S. Cl. 210/639; 528/391; 210/500.38; 210/483; 427/337

(57) ABSTRACT

The present disclosure relates to a matrix comprising a modified sulfonamide polymer, processes for producing the same and uses thereof. In particular, the matrix comprises sulfonyl compound residues and aliphatic amine compound residues, and further comprises acyl compound residues and amine compound residues having at least two amine moieties, wherein the aliphatic amine compound residues and amine compound residues are different.

### FIELD OF THE DISCLOSURE

The present disclosure relates to modified sulfonamide polymeric matrices, processes for producing the same and uses thereof. The disclosure also relates to methods for modifying a property of a reverse osmosis or nanofiltration membrane comprising a modified sulfonamide polymeric matrix.

### BACKGROUND

Reverse osmosis or nanofiltration membranes are generally fabricated by interfacial polymerization of a monomer in a nonpolar (e.g. organic) phase together with a monomer in a polar (e.g. aqueous) phase on a porous support membrane and are used, for example, in the purification of water. Such membranes are subject to fouling resulting in reduced flux as contaminants, for example from the water to be purified, build up on the surface of the membrane.

The general strategy for improving sulfonamide membrane performance has focused on monomer selection or the treatment of the membrane after fabrication, such as by the addition of swelling agents prior to drying of the polymer membrane.

### SUMMARY

The present disclosure relates to matrices comprising a sulfonamide polymer, wherein the matrices are useful in membrane technology, for example a water-permeable reverse osmosis (RO) membrane or a nano-filtration (NF) membrane. In one embodiment, certain monomeric units which compose the polymeric matrix are selected to modify at least one property of the matrix, and in particular, modify the performance of the reverse osmosis or nanofiltration membranes with respect to the A-value (flux) of the membrane and/or the salt selectivity (for example, the monovalent to divalent selectivity ratio) of the membrane.

Accordingly, the present disclosure relates to a modified sulfonamide polymeric matrix, wherein the polymer matrix is composed of

(i) sulfonyl compound residues having at least two sulfonyl moieties; and

(ii) aliphatic amine compound residues having at least two amine moieties; and is further composed of at least one of:

(iii) acyl compound residues having at least two acyl moieties; and/or

(iv) amine compound residues having at least two amine moieties,

wherein the aliphatic amine compound residues and amine compound residues are different.

In another embodiment, the present disclosure also includes a polymeric reaction product formed from interfacial polymerization of:

(i) an aliphatic polyamine monomer; and

(ii) an amine reactive polysulfonyl monomer; and at least one of:

(iii) a polyamine monomer; and/or

(iv) an amine reactive polyacyl monomer,

wherein the aliphatic polyamine monomer and the polyamine monomer are different.

The present disclosure also includes a use of a modified sulfonamide polymeric matrix to form thin-film composite membranes (such as reverse osmosis membranes and/or nanofiltration membranes), which are then used in applications such as water purification devices and selective separation systems for aqueous and organic liquids carrying dissolved or suspended components. In one embodiment, the polymeric matrix comprising a modified sulfonamide polymer matrix is formed on a porous substrate for use as thin-film composite membranes, such as reverse osmosis or nanofiltration membranes.

The disclosure also includes methods of treating water, for example the desalination of seawater, comprising passing the water through a membrane comprising a modified sulfonamide polymeric matrix of the disclosure, for example, in a reverse osmosis or nanofiltration process.

In another embodiment, the present disclosure also includes a process for preparing a modified sulfonamide matrix, and in particular, a process for preparing a reverse osmosis or nano-filtration membrane comprising a modified sulfonamide matrix, the process comprising:

contacting a porous substrate with:
an aqueous solution comprising
   (i) an aliphatic polyamine monomer; and
   (ii) a first optional component comprising a polyamine monomer; and
an organic solution comprising
   (iii) an amine reactive polysulfonyl monomer; and
   (iv) a second optional component comprising an amine reactive polyacyl monomer;
      wherein at least one of the first and second optional components are present in the aqueous and/or organic solutions and wherein the aliphatic polyamine monomers and the polyamine monomers are different.

The present disclosure also provides methods of modifying the performance of a reverse osmosis membrane comprised of a modified sulfonamide polymeric matrix, by treating the membrane after it has been prepared. In particular, the disclosure provides a method of modifying a property of a reverse osmosis (RO) or nano-filtration membrane comprising a modified sulfonamide polymeric matrix, the method comprising contacting the membrane with a polyol solvent and/or a surfactant for a time sufficient to modify the property of the membrane.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

Embodiments of the disclosure will be described in relation to the drawings in which:

FIG. 1 is a graph illustrating the passage of salts through a membrane vs. the A-value of a membrane representing an embodiment of the disclosure;

FIG. 2 is a graph illustrating the passage of salts through a membrane vs. the A-Value of a membrane of a membrane representing an embodiment of the disclosure in which a polyamine monomer has been added to the aqueous solution;

FIG. 3 is a graph illustrating the passage of salts through a membrane vs. the A-value of the membrane as a function of the ratio of a polyamine monomer relative to the total aliphatic polyamine monomer concentration in an aqueous solution;

FIG. 4 is a graph illustrating the passage of salts through a membrane vs. the A-Value of the membrane as a function of the amount of an amine reactive polyacyl monomer added to an organic solution;

FIG. 5 is a graph illustrating the passage of salts through a membrane vs. the A-value of the membrane as a function of the amount of an amine reactive polyacyl monomer added to an organic solution and/or a polyamine monomer added to an aqueous solution; and

FIG. 6 is a graph illustrating the passage of salts through a membrane vs. the A-Value of the membrane as a function of the amount of a surfactant contacting a commercial sulfonamide membrane.

### DETAILED DESCRIPTION

### (I) Definitions

Unless otherwise indicated, the definitions and embodiments described in this and other sections are intended to be applicable to all embodiments and aspects of the application herein described for which they are suitable as would be understood by a person skilled in the art.

The terms “a,” “an,” or “the” as used herein not only include aspects with one member, but also includes aspects with more than one member. For example, an embodiment including “an aliphatic amine monomer” should be understood to present certain embodiments with one aliphatic amine monomer or certain embodiments with two or more additional aliphatic amine monomers.

In embodiments comprising an “additional” or “second” component, the second component as used herein is chemically different from the other components or first component. A “third” component is different from the other, first, and second components, and further enumerated or “additional” components are similarly different.

The term “matrix” means a regular, irregular and/or random arrangement of polymer molecules. The molecules may or may not be cross-linked. On a scale such as would be obtained from SEM, x-ray or FTNMR, the molecular arrangement may show a physical configuration in three dimensions like those of networks, meshes, arrays, frameworks, scaffoldings, three dimensional nets or three dimensional entanglements of molecules. The matrix is usually non-self supporting and most often is constructed as a coating or layer on a support material.

The term “modified sulfonamide polymeric matrix” as used herein refers to a polymer which is composed of (i) sulfonyl compound residues having at least two sulfonyl moieties; (ii) aliphatic amine compound residues having at least two amine moieties, and further composed of at least one of (iii) acyl compound residues having at least two acyl moieties; and/or (iv) amine compound residues having at least two amine moieties.

The term “sulfonyl” and “sulfonyl moiety” refers to the functional group “SO₂”, also represented by the formula:

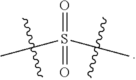

The term “acyl” and “acyl moiety” refers to the functional group “C(O)”, also represented by the formula:

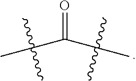

The term “amine” and “amine moiety” refers to a functional grouping containing a basic nitrogen atom with a lone pair of electrons. Amines are derivatives of ammonia (NH₃) where one or more of the hydrogen atoms have been replaced with an alkyl or aryl group. Primary amines have the structure R′—NH₂, secondary amines have the structure R′R″NH and tertiary amines have the structure R′R″R′″N, wherein R′, R″ and R′″ are an alkyl or aryl group.

The term “sulfonamide” refers to a chemical moiety of the formula:

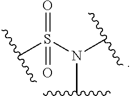

The term “amide” refers to a chemical moiety of the formula:

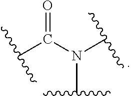

The term “residues” as used herein refers to a chemical formed by the polymerization of a monomer. Therefore a sulfonyl compound residue refers to the chemical grouping formed when a polysulfonyl monomer is polymerized, an aliphatic amine compound residue refers to the chemical grouping when an aliphatic amine monomer is polymerized, an acyl compound residue refers to the chemical grouping when an polyacyl monomer is polymerized and an amine compound residue refers to the chemical grouping when an amine monomer is polymerized

The term “aliphatic polyamine monomers” as used herein refers to monomers which comprise at least two nucleophilic primary or secondary amino groups, in which the aliphatic portion of the monomer is a branched or unbranched, saturated or unsaturated alkyl chain, containing between 2 and 20 carbon atoms, and in which one or more of the carbon atoms is optionally replaced by a heteromoiety selected from O, S, NH and NC₁₋₆alkyl. In one embodiment, the aliphatic amine monomers are able to react with amine reactive polysulfonyl monomers and/or amine reactive polyacyl monomers to form a modified sulfonamide polymer matrix. It will be understood by those skilled in the art that aliphatic polyamine monomers refer to the compounds used to prepare the polymer, while the term “aliphatic amine compound residues” refers to the compounds that have already been polymerized, and which are therefore residues within the polymeric matrix. In one embodiment, the aliphatic polyamine monomers are soluble in an aqueous solution.

The term “amine reactive polysulfonyl monomers” as used herein refers to a compound comprising at least two (electrophilic) sulfonyl moieties of the formula:

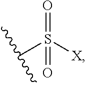

wherein X is a leaving group and which are therefore able to react with nucleophilic amine moieties to form a sulfonamide polymer.

The term “polyamine monomer” as used herein refers to monomers comprising at least two nucleophilic primary or secondary amino groups, which are able to react with amine reactive polysulfonyl monomers and/or amine reactive polyacyl monomers to form a modified sulfonamide polymeric matrix, which are soluble in an aqueous solution, and which are different from the aliphatic polyamine monomers. In one embodiment, the polyamine monomer is any polyamine having the above described characteristics which can modify a property of a RO or NF membrane. It will be understood that aliphatic polyamine monomers can be selected as a polyamine monomer, if it is different from the selected aliphatic polyamine monomer. It will be understood by those skilled in the art that polyamine monomer units refer to the compounds used to prepare the polymer, while the term “amine compound residues” refers to the compounds that have been polymerized, and which are therefore residues within the polymeric matrix.

The term “amine reactive polyacyl monomer” as used herein refers to a compound containing at least two reactive (electrophilic) acyl moieties of the formula:

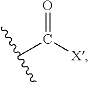

wherein X′ is a leaving group and which are therefore able to react with nucleophilic amine moieties to form an amide in the modified sulfonamide polymeric matrix. It will be understood that the presence of the amine reactive polyacyl monomer results in the substitution of at least one polysulfonyl compound residue with a polyacyl compound residue within the sulfonamide polymer. Examples of leaving groups (X′) include halogens (chloride, fluoride, bromide and iodide), anhydrides, activated esters, and other leaving groups such as tosylates, mesylates, triflates etc.

The terms “halogen”, “halide” or “halo” as used herein include chloro, fluoro, bromo or iodo.

The phrase “modify at least one property of a membrane” as used herein refers to a property of a membrane, for example a RO or NF membrane, such as the A-value (flux capacity) or salt selectivity of the membrane, that is desirably modified to alter the performance of the membrane. For example, for a particular application, such as seawater desalination, it may be desirable to increase the A-value of the membrane (such as RO or NF), and this can be accomplished by selecting the appropriate monomeric units of the disclosure to form the sulfonamide polymer (or modified sulfonamide polymer). In addition, in another example, the salt selectivity with respect to the selectivity ratio of monovalent vs. divalent salts is modified. For example, in one embodiment, the selectivity of monovalent vs divalent salts is modified such that the membrane comprising the polymeric matrix increases the rejection of divalent salts (i.e. increases the amount of divalent salts in the retentate) and decreases the rejection of monovalent salts (ie. increases the amount of monovalent salts in the permeate). Depending on the property that is desirably modified, a person skilled in the art will be able to select the appropriate monomeric units as described in the present disclosure to form the modified sulfonamide polymer having the necessary properties.

The term “C_{a-b}-(alkylene)” as used herein means straight and/or branched chain, saturated alkylene radicals containing from “a” to “b” carbon atoms in which one or more of the carbon atoms is optionally replaced by a heteromoiety selected from O, S, NH and NC₁₋₆alkyl, and includes (depending on the identity of “a” and “b”) methylene, ethylene, propylene, isopropylene, n-butylene, s-butylene, isobutylene, t-butylene, 2,2-dimethylbutylene, n-pentylene, 2-methylpentylene, 3-methylpentylene, 4-methylpentylene, n-hexylene and the like, where the variable “a” is an integer representing the lowest number of carbon atoms and the variable “b” is an integer representing the largest number of carbon atoms in the alkylene radical.

The term “C_{a-b}-(alkenylene)” as used herein means straight and/or branched chain, saturated alkenylene radicals containing from “a” to “b” carbon atoms and at least one double bond (for example, 1, 2, 3 or 4 double bonds), in which one or more of the carbon atoms is optionally replaced by a heteromoiety selected from O, S, NH and NC₁₋₆alkyl, and includes (depending on the identity of “a” and “b”) ethenylene, propenylene, isopropenylene, n-butenylene, s-butenylene, isobutenylene, t-butenylene, 2,2-dimethylbutenylene, n-pentenylene, 2-methylpentenylene, 3-methylpentenylene, 4-methylpentenylene, n-hexenylene and the like, where the variable “a” is an integer representing the lowest number of carbon atoms and the variable “b” is an integer representing the largest number of carbon atoms in the alkenmylene radical.

The term “C₁₋₆-(alkyl)” as used herein means straight and/or branched chain, saturated alkyl radicals and includes methyl, ethyl, propyl, isopropylene, n-butyl, s-butyl, isobutyl, t-butyl, 2,2-dimethylbutyl, n-pentyl, 2-methylpentyl, 3-methylpentyl, 4-methylpentyl, n-hexyl and the like.

The term “C₂₋₆-(alkenyl)” as used herein means straight and/or branched chain, unsaturated alkyl radicals containing one or more (for example, 1, 2 or 3) double bonds and includes ethenyl, propenyl, isopropenyl, n-butenyl, s-butenyl, isobutenyl, t-butenyl, 2,2-dimethylbutenyl, n-pentenyl, 2-methylpentenyl, 3-methylpentenyl, 4-methylpentenyl, n-hexenyl and the like.

The term “aliphatic” or “aliphatic group” is known in the art and includes branched or unbranched carbon chains which are fully saturated (alkyl) or which comprise one or more (e.g. 1, 2, 3, or 4) double (alkenyl) in the chain.

The term “cycloaliphatic” or “cycloaliphatic group” is known in the art and includes mono-cyclic and poly-cyclic hydrocarbons which are fully saturated (cycloalkyl) or which comprise one or more (e.g. 1, 2, 3, or 4) double bonds (cycloalkenyl) in the ring(s).

The term “aryl” denotes a phenyl radical or an ortho-fused bicyclic carbocyclic group having about 9 to 14 atoms in which at least one ring is aromatic. Representative examples include phenyl, indenyl, naphthyl, and the like

The term “A value” as used herein refers to the permeate flux capacity RO water permeability of a membrane and is represented by the cubic centimeters of permeate water over the square centimeters of membrane area times the seconds at the pressure measured in atmospheres.

The term “permeation” or “permeate” means transmission of a material through a membrane.

The term “membrane” when used in the context of a reverse osmosis membrane or nano-filtration membrane as used herein refers to a selective barrier which is used to separate dissolved components of a feed fluid into a permeate (for example, water) that passes through the membrane and a retentate (for examples, salts) that is rejected or retained by the membrane. It will be understood that the modified sulfonamide polymeric matrices of the present disclosure are supported by a substrate to form the membrane, and the polymeric matrices separate the dissolved components. The substrate is not involved in the separation of the dissolved components.

The term “substrate” means any substrate or support material onto which the matrix can be applied. The substrate may be porous or non-porous.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having”, “containing” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### (II) Matrices and Membranes

The present disclosure relates to a polymeric matrix comprising a modified sulfonamide polymer, wherein the matrix is useful in membrane technology, such as in reverse osmosis (RO) membranes or a nano-filtration membranes. The selection of the appropriate monomeric units which comprise the modified sulfonamide polymer matrix allows for a membrane to be tuned with respect to flow and rejection performance. In one embodiment, also included in the disclosure are reverse osmosis membranes or nanofiltration membranes comprising a substrate and a modified sulfonamide polymeric matrix of the present disclosure.

Accordingly, the present disclosure relates to a modified sulfonamide polymeric matrix, wherein the polymer matrix is composed of

(i) sulfonyl compound residues having at least two sulfonyl moieties; and

(ii) aliphatic amine compound residues having at least two amine moieties; and is further composed of at least one of:

(iii) acyl compound residues having at least two acyl moieties; and/or

(iv) amine compound residues having at least two amine moieties,

wherein the aliphatic amine compound residues and amine compound residues are different.

In one embodiment, the polymeric matrix is formed on a substrate to provide a thin-film composite membrane, and the membrane is a water-permeable reverse osmosis (RO) membrane or a nano-filtration membrane.

In another embodiment, the selection of the amine compound residue and/or acyl compound residue allows for the modification of a property or performance of the membrane, for example with respect to the flow of a liquid through the membrane and/or the rejection of materials dissolved and/or carried in the liquid which passes through the membrane. As such, when the sulfonamide polymer matrices of the present disclosure are used as membranes (such as RO or NF membranes), the selection of the amine compound residues and/or the acyl compound residues, modifies at least one property of a membrane, wherein the property of the membrane is the A-value or the salt selectivity of the membrane. In another embodiment, the amine compound residues and/or the acyl compound residues modify the selectivity of the membrane with respect to the ratio of monovalent and divalent salts which are able to pass through the membrane.

In one embodiment of the disclosure, the aliphatic amine compound residues are derived from monomers comprising at least two reactive amino moieties. In another embodiment, the aliphatic amine compound residue is a residue of the formula (I)

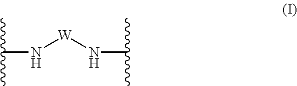

wherein W is a (C₂₋₂₀)-alkylene group or a (C₂₋₂₀)-alkenylene group, and wherein at least one carbon atom, optionally at least two carbon atoms, in the alkylene or alkenylene group is optionally replaced by O, S, NH or N(C₁₋₆)alkyl moieties, suitably NH or N(C₁₋₆)alkyl moieties. In another embodiment, W is a (C₄₋₁₀)-alkylene group wherein at least one carbon atom, optionally at least two carbon atoms, in the alkylene group is optionally replaced by NH or N(C₁₋₆)alkyl moieties. In another embodiment of the disclosure, the aliphatic amine compound residue of the formula (I) is

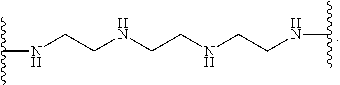

In another embodiment of the disclosure, the sulfonyl compound residue is a residue of the formula (II)

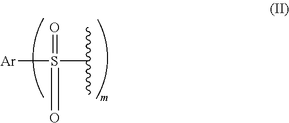

wherein m is an integer between 2 and 4; and
Ar is an aryl group containing between 6-14 carbon atoms.

In a further embodiment, the sulfonyl compound residue of the formula (II) is

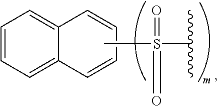

wherein m is an integer between 2 and 3.

In an embodiment, the sulfonyl compound residue of the formula (II) is

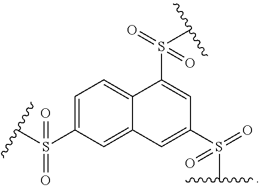

In another embodiment of the disclosure, the amine compound residue is an aromatic amine compound residue, a cycloaliphatic amine compound residue or an aliphatic amine compound residue as defined above.

In a further embodiment, the aromatic amine compound residue is a residue of the formula (III)

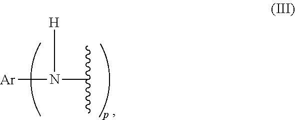

wherein Ar is an aryl group containing between 6-14 carbon atoms; and p is an integer between 2 and 3.

In another embodiment, the aromatic amine compound residue of the formula (III) is

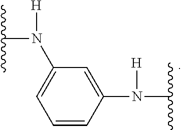

In another embodiment of the disclosure, the cycloalkyl amine compound residue is a residue of the formula (IV)

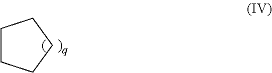

wherein q is an integer between 1 and 4,
and wherein at least two of the carbon atoms are replaced by N atoms that participate in bonding with the polymer matrix.

In another embodiment, the cycloalkyl amine compound residue of formula (IV) is

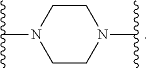

In another embodiment of the disclosure, the acyl compound residue is a residue of the formula (V)

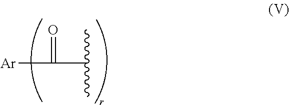

wherein r is an integer between 2 and 4; and
Ar is an aryl group containing 6-14 carbon atoms.

In another embodiment, the acyl compound residue of formula (V) is

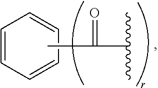

wherein r is an integer between 2 and 3.

In another embodiment, the acyl compound residue of formula (V) is

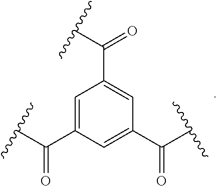

In one embodiment, the polymeric matrix is formed by the reaction of amine reactive polysulfonyl monomer (such as a polysulfonyl halide) and an aliphatic polyamine monomer, and further from monomers of a different polyamine and/or amine reactive polyacyl monomers (for example a polyacyl halide). For example, in one embodiment, acyl compound residues containing at least two acyl moieties (derived from, for example amine reactive polyacyl monomers) replace a certain percentage (depending on concentrations of the reactants) of the sulfonyl compound residues of the modified sulfonamide polymeric matrix. In one embodiment, the sulfonamide polymer is a low pH stable polymer.

Accordingly, in an embodiment, the present disclosure also includes a polymeric reaction product formed from interfacial polymerization of:

(i) an aliphatic polyamine monomer; and

(ii) an amine reactive polysulfonyl monomer; and at least one of:

(iii) a polyamine monomer; and/or

(iv) an amine reactive polyacyl monomer,

wherein the aliphatic polyamine monomer and the polyamine monomer are different.

In another embodiment, the present disclosure also relates to the polymeric reaction product prepared on a substrate to form a membrane, wherein the polymeric reaction product is formed from interfacial polymerization of:

(i) an aliphatic polyamine monomer; and

(ii) an amine reactive polysulfonyl monomer; and at least one of:

(iii) a polyamine monomer; and/or

(iv) an amine reactive polyacyl monomer,

wherein the aliphatic polyamine monomer and the polyamine monomer are different.

In one embodiment, the polymer is useful as a membrane is a water-permeable reverse osmosis (RO) membrane or a nano-filtration membrane.

In another embodiment, the selection and addition of the polyamine and/or amine reactive polyacyl monomers (to the reaction mixture of the interfacial polymerization) allows for the modification of a property or performance of a membrane, for example with respect to the flow of a liquid through the membrane and/or the rejection of materials dissolved and/or carried in the liquid. As such, when a modified sulfonamide polymer matrices of the present disclosure are used as membranes (such as RO or NF membranes), the selection of the polyamine and/or the amine reactive polyacyl monomers modify at least one property of a membrane. In an embodiment, the property of the membrane is the A-value or the salt selectivity of the membrane. In another embodiment, the polyamine and/or the amine reactive polyacyl monomers modify the selectivity of the membrane with respect to the ratio of monovalent and divalent salts which are able to pass through the membrane.

In one embodiment of the disclosure, the aliphatic polyamine monomer comprises at least two reactive amino moieties. In another embodiment, the aliphatic polyamine monomer is a compound of the formula (VI)

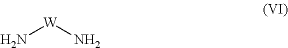

wherein W is a (C₂₋₂₀)alkylene group is a (C₂₋₂₀)-alkylene group or a (C₂₋₂₀-alkenylene group, and wherein at least one carbon atom, optionally at least two carbon atoms, in the alkylene or alkenylene group is optionally replaced by O, S, NH or N(C₁₋₆)alkyl moieties, suitably NH or N(C₁₋₆)alkyl moieties. In another embodiment, W is a (C₄₋₁₀)-alkylene group wherein at least one carbon atom, optionally at least two carbon atoms, in the alkylene group is optionally replaced by NH or N(C₁₋₆)alkyl moieties. In one embodiment, the aliphatic polyamine monomer is, triethylenetetraamine, ethylenediamine, propylenediamine, or tris(2-aminoethyl)amine. In another embodiment of the disclosure, the monomer of the formula (VI) is

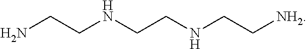

In another embodiment of the disclosure, the amine reactive polysulfonyl monomer is a monomer of the formula (VII)

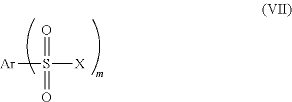

wherein m is an integer between 2 and 4; and
Ar is an aryl group containing between 6-14 carbon atoms; and
X is a leaving group.

In a further embodiment, the amine reactive polysulfonyl monomer of formula (VII) is

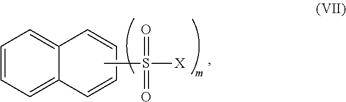

wherein m is an integer between 2 and 3, and
X is a leaving group.

Specific examples of amine reactive polysulfonyl monomer include, but are not limited to, aromatic sulfonyl halides such as naphthalenesulfonyl halide (for example, 1,3,6-naphthalenetrisulfonyl halide) or benzene-sulfonyl halide (for example, 1,3,5-benzene sulfonyl halide).

In an embodiment, the amine reactive polysulfonyl monomer of formula (VII) is

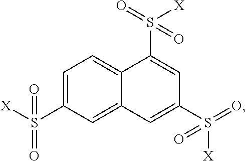

wherein X is a leaving group.

In another embodiment, the leaving group X is halogen, such as chloro, bromo, iodo or fluoro. In one embodiment, the leaving group is chloro.

In another embodiment of the disclosure, the polyamine monomer comprises an aromatic polyamine monomer, a cycloalkyl polyamine monomer or an aliphatic polyamine monomer.

In a further embodiment, the aromatic polyamine monomer is a monomer of the formula (VIII)

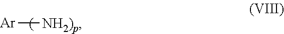

wherein Ar is an aryl group containing between 6-14 carbon atoms; and p is an integer between 2 and 3. Examples of aromatic polyamine monomers include, but are not limited to, diaminobenzene, m-phenylenediamine, p-phenylenediamine, triaminobenzene, 1,3,5-triaminobenzene, 1,3,4-triaminobenzene, 2,4-diaminotoluene, xylylene-diamine and the like.

In another embodiment, the aromatic polyamine monomer of formula (VIII) is

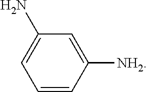

In another embodiment of the disclosure, the cycloalkyl polyamine monomer is a monomer of the formula (IX)

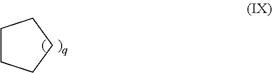

wherein q is an integer between 1 and 4,
and wherein at least two of the carbon atoms are replaced with —NH. Examples of cycloaliphatic polyamine monomers include, but are not limited to, piperazine, imidazolidine, diazepane and isomers and the like.

In another embodiment, the cycloalkyl polyamine monomer of formual (IX) is

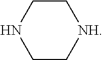

In another embodiment of the disclosure, the amine reactive polyacyl monomer is a compound of the formula (XI)

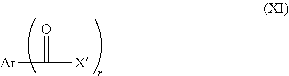

wherein r is an integer between 2 and 4; and
Ar is an aryl group containing 6-14 carbon atoms; and
X′ is a leaving group. Examples of amine reactive polyacyl monomers include, but are not limited to, aromatic acyl halides such as trimesoyl halide, trimellitic halide, isophthaloyl halide, terephthaloyl halide, and the like.

In another embodiment, the amine reactive polyacyl monomer of formula (XI) is

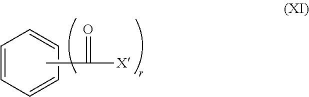

wherein r is an integer between 2 and 3; and
X′ is a leaving group.

In another embodiment, the amine reactive polyacyl monomer is

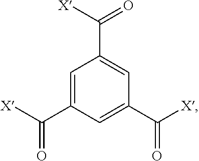

wherein X′ is a leaving group.

In another embodiment, the leaving group X′ is halogen, such as chloro, bromo, iodo or fluoro. In one embodiment, the leaving group, X′, is chloro.

### (III) Processes, Devices and Uses

The present disclosure also includes a process for preparing a membrane, such as an RO or MF membrane, comprising a modified sulfonamide polymeric matrix and a substrate. In one embodiment, the process includes preparing a modified sulfonamide polymeric matrix on a substrate, wherein the process comprises an interfacial polymerization process. Accordingly, in one embodiment of the disclosure, there is included a process for preparing a modified sulfonamide polymeric matrix to form a membrane (such as a RO or NF membrane), the process comprising:

contacting a substrate with:

an aqueous solution comprising
(i) aliphatic polyamine monomers; and
(ii) a first optional component comprising polyamine monomers; and

an organic solution comprising
(iii) amine reactive polysulfonyl monomers; and
(iv) a second optional component comprising amine reactive polyacyl monomers;
   wherein at least one of the first and second optional components are present in the aqueous and/or organic solutions, the aliphatic polyamine monomers and the polyamine monomers are different and the modified sulfonamide polymeric matrix, the aliphatic polyamine monomers, the polyamine monomers, the amine reactive polysulfonyl monomers and the amine reactive polyacyl monomers are all as defined above.

In another embodiment of the disclosure, both the aqueous solution and the organic solution contain the optional component.

In one embodiment, the substrate is first contacted with the aqueous solution and subsequently with the organic solution, or in another embodiment, the substrate is first contacted with the organic solution and then subsequently with the aqueous solution.

In another embodiment of the disclosure, the process is conducted in the presence of a non-nucleophilic base, such as 4-dimethylaminopyridine (DMAP) or pyridine.

In an embodiment, the aqueous solution comprises water and aliphatic polyamine monomers in an amount between 0-5% (wt/wt), 0.1-2% (wt/wt), or about 1.1% (wt/wt), and the optional polyamine monomers are present in an amount between 0-5.0% (wt/wt), optionally 0.1-2% (wt/wt), or 0.1-1% (wt/wt) or about 0.25% (wt/wt). In another embodiment, the organic solution comprises an organic solvent such as mesitylene, toluene, hydrocarbons (such as Isopar G), or mixtures thereof, and contains amine reactive polysulfonyl monomers in an amount between 0.1-2% (wUwt), between 0.2-1.0% (wt/wt) or about 0.32% (wt/wt), and the amine reactive polyacyl monomers are present in an amount between 0.1-2% (wt/wt), between 0.2-1.0% (wt/wt) or about 0.50% (wt/wt).

Methods for the interfacial polymerization to form non-modified polysulfonamide matrices are described for example, in U.S. Pat. No. 6,837,996, the contents of which are incorporated herein by reference in their entirety.

The membrane may be further processed to remove residual chemicals, adjust performance, and/or to apply a protective coating. For example, post formation treatment with chlorinating agents, amine methylating agents, oxidizing agents and the like may provide performance improvements. After such optional treatment, the membrane is ready for use. The membrane may also be stored for later use.

As described above, the selection and addition (to the reaction mixture of the interfacial polymerization process) of the polyamine monomer and/or the amine reactive polyacyl monomer results in the modification of at least one property of a membrane (for example, an RO or NF membrane), when the polymeric matrices of the disclosure are used as membranes. Likewise, in one embodiment, a polyamine such as m-phenylenediamine is also added to increase the selectivity of the salt ratio (divalent vs. monovalent), such that the passage of monovalent salts (such as sodium chloride) through a membrane is decreased. In another embodiment, if it is desirable to increase the A value of a membrane, a polyamine monomer such as piperazine is added to the reactant mixture. In a further embodiment, if it is desirable to increase the A value of a membrane and to increase the passage of monovalent salts (such as sodium chloride), an amine reactive polyacyl monomer, such as trimesoyl chloride, is added to the reactant mixture. Accordingly, depending on the property that is desirably modified, a person skilled in the art will be able to select the appropriate monomeric units as described in the present disclosure to form the modified sulfonamide polymeric matrices which are useful in membranes having the necessary properties.

In another embodiment of the disclosure, there is also included a method for modifying a property of a membrane, such as a RO or NF membrane, the method comprising forming a modified sulfonamide polymeric membrane as defined above on a substrate to form a membrane, wherein the selection of the polyamine monomer and/or the amine reactive polyacyl monomer as defined above allows for the modification of a desired property of the RO or NF membrane. In one embodiment, the property of the membrane comprises the A value of the membrane or the salt selectivity of the membrane. In one embodiment, the method comprises selecting a polyamine monomer and/or an amine reactive polyacyl monomer to prepare a modified sulfonamide polymeric matrix as defined above.

The modified sulfonamide polymer matrices of the present disclosure may be formed into the composite membranes of the present disclosure and incorporated into filtration, separation, concentration apparatuses as well as medical devices, blood treatment devices and the like. These devices are also useful for water purification, for desalination, for industrial waste treatment, for minerals recovery such as from the mining industry, and for recovery of application solids from industrial processing. Further uses include layers or coatings upon the surface of any substrate including but not limited to a porous bead, a chromatographic material, a metal surfaces, a microdevice, a medical device, a catheter and the like. These coatings may act as lubricants, antibiotics, reservoirs, and/or filters for agents passed over the coated substrate. The coatings may also carry biological agents (e.g. antibodies, antibiotics, anti blood plasma coagulants, nucleotides, pharmaceuticals, and the like). The matrix may also be used to encapsulate and also to allow controlled release of pharmaceutical agents, diagnostic agents, cosmetics, and the like.

In an embodiment, the polymeric matrices of the present disclosure are useful in membrane technology for the treatment of water, for example, the desalination of seawater. Accordingly, the disclosure includes methods of treating water, such as seawater, comprising filtering the water with a membrane (such as an RO or NF membrane) comprising a modified sulfonamide polymeric matrix of the present disclosure supported on a substrate to remove ions such as sodium, magnesium, calcium, potassium, chloride, sulfate, etc. In another embodiment, membranes using the matrices of the present disclosure are also useful in water purification devices and selective separation systems for aqueous and organic liquids carrying dissolved or suspended components.

The disclosure also includes methods of treating water, for example the desalination of seawater, comprising passing the water through a membrane comprising a modified sulfonamide polymeric matrix of the disclosure in a reverse osmosis or nano-filtration process.

The composite membranes of the present disclosure can be used in any configuration or arrangement to achieve separation of solute from solvent. These configurations include partition, absolute filtration, chromatography, exchange and pass through concentration as well as other configurations known in the art. Although dead end filtration and chromatography configurations can be used with the composite membranes of the present invention, cross-flow filtration is optimal. Dead-end configurations call for passage of all solvent through the composite membrane and retention of solute at the filtration side of the composite membranes. The buildup of solute at the membrane surface may cause caking. In these configurations, the filtration apparatus must be periodically back flushed in order to remove cake solids or the filter discarded. Cross-flow configurations involve partial pass through of the feed liquid such that rejected solute is continually flushed away from the filtering membrane surface and passed with the retentate.

### (IV) Methods for Modifying the Performance of Membranes Comprising a Modified Sulfonamide Polymeric Matrix

The present disclosure also includes methods of modifying the performance of a membrane, such as a RO or NF membrane, for example a membrane comprising the modified sulfonamide polymeric matrices of the disclosure. In particular, the disclosure includes methods for modifying the A value of a membrane or the salt selectivity of a membrane. Accordingly, in one embodiment, the present disclosure includes a method of modifying a property of a membrane comprising a modified sulfonamide polymeric matrix supported on a substrate, the method comprising contacting the membrane with a polyol solvent and a surfactant for a time sufficient to modify the property of the membrane. In one embodiment, the modified sulfonamide polymeric matrix is as defined above.

In one embodiment, the property of the membrane that is modified is the A value of the membrane or the salt selectivity of the membrane. In another embodiment, the A-value is increased as compared to a membrane that is not contacted with a polyol and a surfactant. In another embodiment, the salt selectivity of the membrane is modified to increase the divalent to monovalent selectivity ratio as compared to a membrane that is not contacted with a polyol and a surfactant In another embodiment, the polyol solvent is glycol, ethylene glycol, diethylene glycol, triethylene glycol or propylene glycol, or a mixture thereof, optionally glycol.

In another embodiment, the surfactant is an anionic surfactant, such as sodium lauryl sulfate, sodium dodecylbenzenesulfonate or sodium dodecyl sulfate, of a mixture thereof, optionally sodium lauryl sulfate.

In another embodiment, the time sufficient to modify the property of the membrane is between 1 and 30 minutes, or about 20 minutes.

In another embodiment, the membranes are contacted with an aqueous solution containing between 1-10% (w/w), 2-5% (w/w), or about 3% (w/w) of the polyol solvent and between 0.01-1.0% (w/w), 0.01-0.5% (w/w), or 0.01-0.20% (w/w) of the surfactant. In another embodiment, the membranes are contacted with the aqueous solution containing the polyol solvent and the surfactant, wherein the aqueous solution has a temperature of between 20° C.-100° C., 40° C.-80° C., or about 60° C.

The following non-limiting examples are illustrative of the present disclosure:

### EXAMPLES

The disclosure will now be described in further details by way of the following examples, wherein the temperatures are indicated in degrees centigrade and the abbreviations have the usual meaning in the art.

### Experimental

A representative synthetic process of a membrane of the disclosure is described herein. Commercially available backing was used as the substrate. First, an aqueous solution consisting of 1.1 (wt:wt %) triethylenetetramine (TETA) and 0.11 (wt:wt %)4-dimethylaminopyridine (DMAP) was applied to the substrate for a 60s dwell. The aqueous solution was poured off and all remaining surface drops were removed via air knife. Next, an organic solution consisting of 0.32 (wt:wt %) 1,3,6-naphthalenetrisulfonyl chloride (NTSC) in 10:90 (wt:wt %) mesitylene: Isopar G was carefully poured over the membrane surface for a 60s dwell. The excess organic solution was poured off and the membrane was placed vertically in a 60° C. oven for 10 minutes.

Samples were tested using 2000 ppm salt solutions (NaCl or MgSO₄ in de-ionized Water) at 225 psig, pH 7, 1 gpm cross flow, 25° C. All samples were as made unless otherwise noted.

### Example 1

### Effect of NTSC Concentration

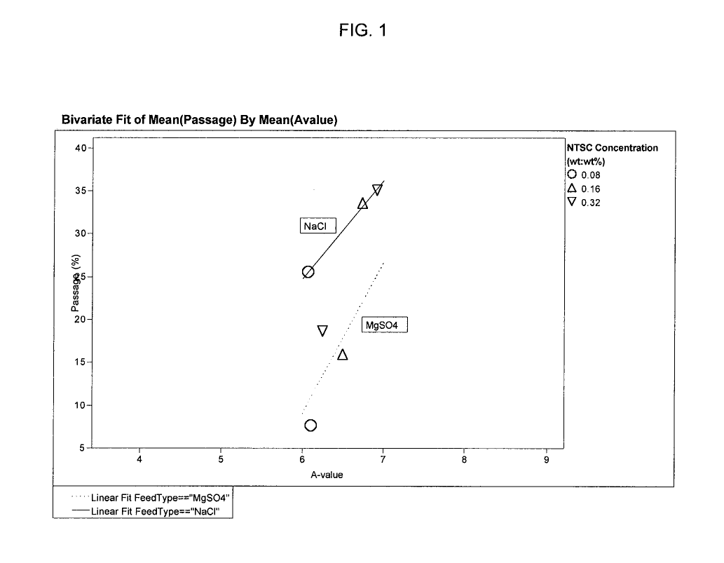

NTSC concentration did not have a significant effect on membrane A-value, but lower NTSC concentrations did have an effect on salt passage (see FIG. 1). Lower NTSC monomer concentrations demonstrated toward lower salt passage, with a 10-15% reduction from 0.32 to 0.08 wt %, as seen in Table 1. These trends were validated on commercial manufacturing equipment. Accordingly, lower concentrations of NTSC yielded membranes with A-values nearly unchanged, but reduced salt passage.

### Example 2

### Effect on Membrane Using m-Phenylenediamine (mPD)

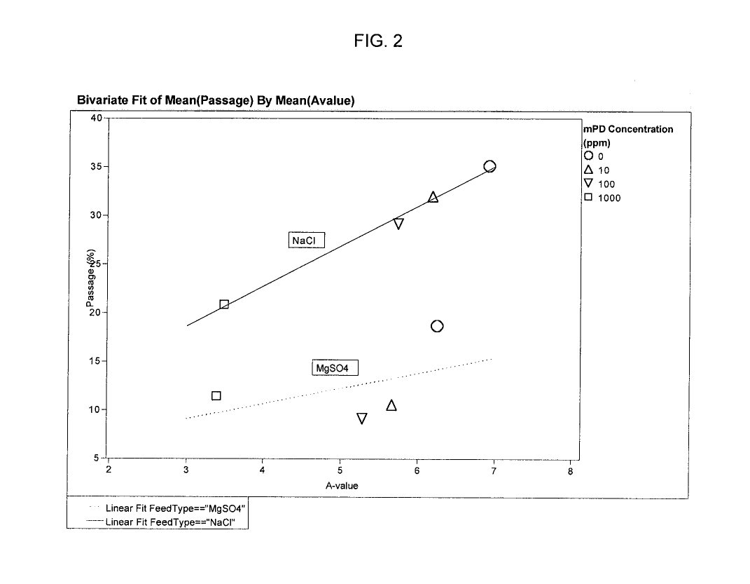

m-phenylenediamine (mPD) was added to the aqueous solution described in the experimental section. The addition of mPD lowered the A-value of the membranes by ˜3.5 units (see FIG. 2). NaCl passage was lowered by ˜15% as more mPD was added, while MgSO₄ passage was comparatively flat. Accordingly, mPD yielded membranes with reduced A-Value and decreased NaCl passage. MgSO₄ passage was statistically constant.

### Example 3

### Effect on Membrane Using Piperazine

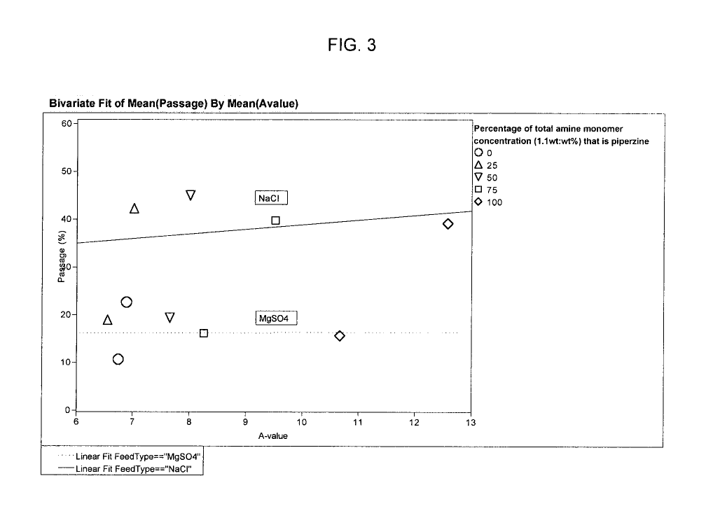

A second amine monomer, piperazine, was used in addition to TETA. The ratio (wt:wt %) of TETA and piperazine was varied, keeping the total concentration (wt %) of amine monomer at 1.1 wt %. (For example, in seen in FIG. 3, 0.25% piperazine would equate to 0.275 wt % piperazine and 0.825 wt % TETA in the aqueous phase). piperazine has a pronounced effect on membrane flow, with membrane A-value nearly doubling moving from 0 to 100% piperazine. Salt passage is statistically unchanged. The NTSC concentration in the organic solution was 0.20 wt % for all conditions. Accordingly, increasing the amount of piperazine increases the flow of the membrane while keeping salt passage flat.

### Example 4

### Effect on Membrane Using Trimesoyl Chloride

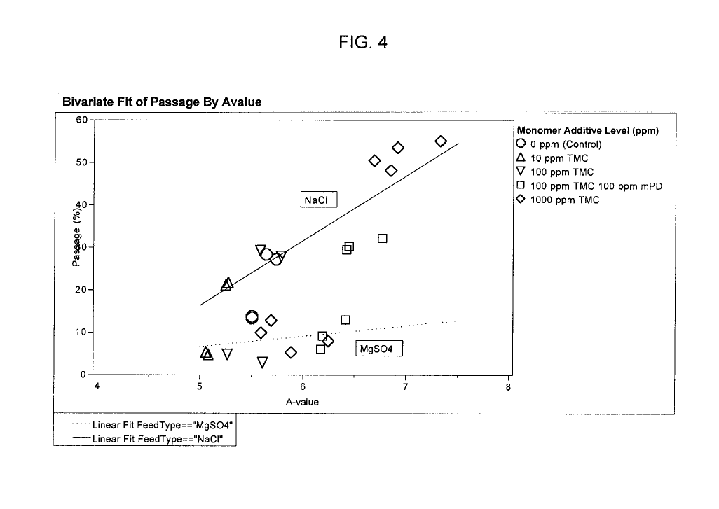

Trimesoyl chloride (TMC) was added to the organic solution containing 0.20 wt % NTSC. The amount of TMC added was recorded in ppm. More TMC caused an increase in membrane A-value, as seen in FIG. 4. MgSO₄ passage was constant, while NaCl passage increased as the amount of TMC increased. Accordingly, the addition of TMC to the organic solution increased the flow and NaCl passage of the membrane, while the MgSO₄ passage stayed constant.

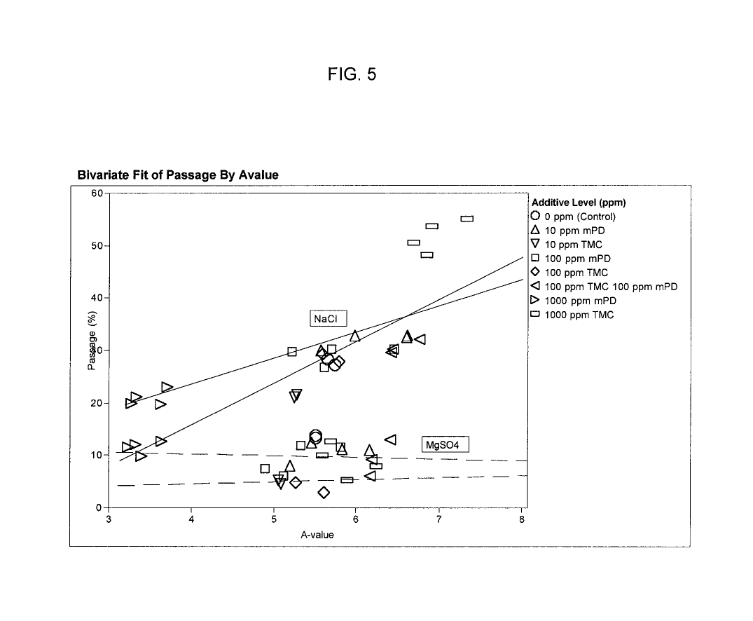

FIG. 5 displays a combined summary of adding mPD and/or TMC to the aqueous and/or organic phases respectively. Both additives had an effect on flow, nearly doubling it from high to low extremes. The effects were opposite in magnitude however. More mPD led to decreased flow, while more TMC led to increased flow. With regard to salt passage, neither membrane had a significant effect on MgSO₄ passage. TMC had a more significant effect on NaCl passage than MgSO₄, with the effect again being opposite in magnitude. Thus, two methods for increasing the monovalent vs. divalent selectivity have been demonstrated: use of an amine reactive polysulfonyl monomer (such as TMC) or a polyamine (such as mPD) as organic or aqueous additives respectively.

### Example 6

### Rinsing of Membranes

Coupons of commercial sulfonamide membrane were soaked in a 60° C. solution of 3 (wt:wt %) glycerin with various amount of sodium lauryl sulfate (SLS) for 2 hours prior to cell testing and tested wet without any drying step.

Coupons of experimental membrane of the disclosure were subjected to a similar treatment, with the exception that the rinsing time was 20 min.

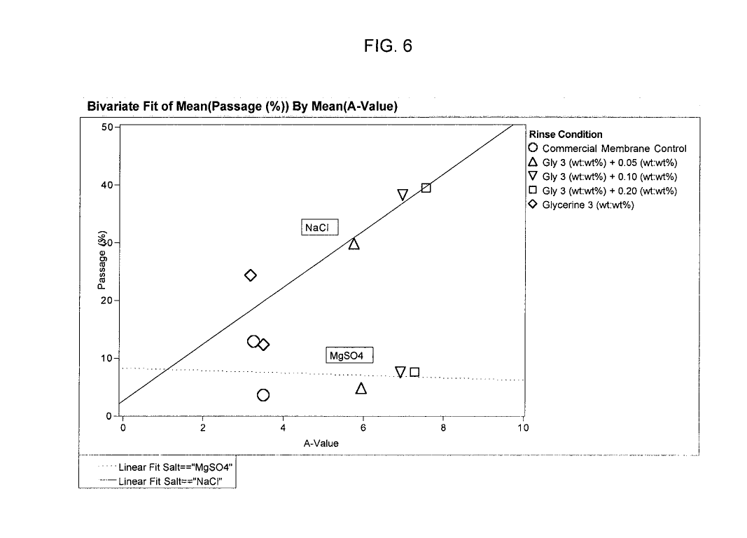

As seen in FIG. 6, the rinsing procedure described above: i) increased the divalent to monovalent salt selectivity ratio; and ii) increased the flow of the membrane.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

TABLE 1
Cell test data from membrane produced on commercial scale coater

| % NTSC | avA | av % T | avB |
|---|---|---|---|
| 0.301 | 6.2 | 0.92 | 0.39 |
| 0.294 | 7.1 | 0.68 | 0.33 |
| 0.269 | 7.6 | 0.74 | 0.39 |

We claim:

1. A modified sulfonamide polymeric matrix, wherein the matrix is composed of
(i) sulfonyl compound residues having at least two sulfonyl moieties; and
(ii) aliphatic amine compound residues having at least two amine moieties; and is further composed of at least one of:
(iii) acyl compound residues having at least two acyl moieties; and/or
(iv) amine compound residues having at least two amine moieties,
wherein the aliphatic amine compound residues and amine compound residues are different.

2. The matrix of claim 1, further comprising a substrate to form a reverse osmosis (RO) membrane or a nano-filtration (NF) membrane.

3. The matrix of claim 2, wherein amine compound residue and/or the acyl compound residue modify at least one property of the RO or NF membrane.

4. The matrix of claim 3, wherein the property of the membrane is the A value or the salt selectivity of the matrix.

5. The matrix of claim 4, wherein the amine compound residues and/or the acyl compound residues modify the selectivity of monovalent and divalent salts of the membrane.

6. The matrix of claim 5, wherein the selectivity of monovalent and divalent salts of the membrane is modified to increase the rejection of divalent salts and decrease the rejection of monovalent salts.

7. The matrix of claim 1, wherein the amine compound residue is derived from monomers comprising at least two nucleophilic primary or secondary amino groups.

8. The matrix of claim 1, wherein the amine compound residue is a residue of the formula (I) 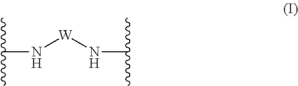
wherein W is a is a (C₂₋₂₀)-alkylene group or a (C₂₋₂₀)-alkenylene group, and wherein at least one carbon atom, optionally at least two carbon atoms, in the alkylene or alkenylene group is optionally replaced by O, S, NH or N(C₁₋₆)alkyl moieties, suitably NH or N(C₁₋₆)alkyl moieties.

9. The matrix of claim 8, wherein at least one carbon atom in the alkylene or alkenylene group is replaced by —NH or —N(C₁-C₆).

10. The matrix of claim 9, wherein W is a (C₄₋₁₀)alkylene group and wherein at least one carbon atom in the alkylene group is replaced by —NH or —N(C₁-C₆).

11. The matrix of claim 9, wherein the residue of formula (I) is

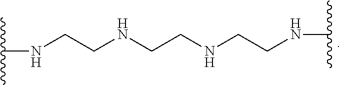

12. The matrix of claim 1, wherein the sulfonyl compound residue is a residue of the formula (II) 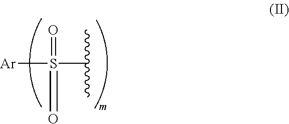
wherein m is an integer between 2 and 4; and
Ar is an aryl group containing 6-14 carbon atoms.

13. The matrix of claim 12, wherein the sulfonyl compound residue of formula (II) is 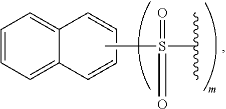
wherein m is an integer between 2 and 3.

14. The matrix of claim 13, wherein the sulfonyl compound residue of formula (II) is

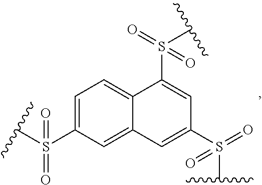

15. The matrix of claim 1, wherein the amine compound residue comprises an aromatic amine compound residue, a cycloaliphatic amine compound residue or an aliphatic amine compound residue.

16. The matrix of claim 15, wherein the aromatic amine compound residue comprises a residue of the formula (III) 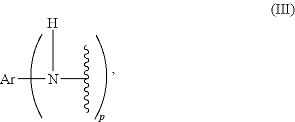
Ar is an aryl group containing between 6-14 carbon atoms; and
wherein p is an integer between 2 and 3.

17. The matrix of claim 16, wherein the aromatic amine compound residue of formula (III) is

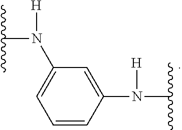

18. The matrix of claim 15, wherein the cycloalkyl amine compound residue is a residue of the formula (IV) 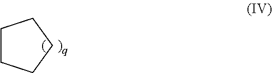
wherein q is an integer between 1 and 4,
and wherein at least two of the carbon atoms are replaced by N atoms that participate in bonding with the polymer matrix.

19. The matrix of claim 18, wherein the cycloalkyl amine compound residue of formula (IV) is

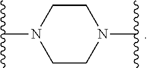

20. The matrix of claim 1, wherein the acyl compound residue is a residue of the formula (V) 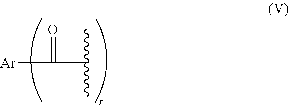
wherein r is an integer between 2 and 4; and
Ar is an aryl group containing 6-14 carbon atoms.

21. The matrix of claim 20, wherein the acyl compound residue of formula (V) is 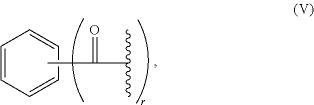
wherein r is an integer between 2 and 3.

22. The matrix of claim 21, wherein the acyl compound residue of formula (V) is

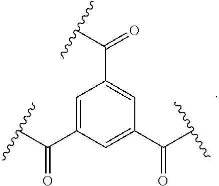

23. A polymeric reaction product prepared on a substrate to form a membrane, wherein the polymeric reaction product is formed from interfacial polymerization of:
(i) aliphatic polyamine monomers; and
(ii) amine reactive polysulfonyl monomers;
and at least one of:
(iii) polyamine monomers; and/or
(iv) amine reactive polyacyl monomers,
wherein the aliphatic polyamine monomers, amine reactive polysulfonyl monomers, polyamine monomers and amine reactive polyacyl monomers, are polymerized to form the sulfonyl compound residues, aliphatic amine compound residues, acyl compound residues and amine compound residues, respectively, as defined in claim 1.

24. A process for preparing a membrane comprising a modified sulfonamide polymeric matrix as defined in claim 1, the process comprising:
contacting a substrate with:
an aqueous solution comprising
(i) aliphatic polyamine monomers; and
(ii) a first optional component comprising polyamine monomers; and
an organic solution comprising
(iii) amine reactive polysulfonyl monomers; and
(iv) a second optional component comprising amine reactive polyacyl monomers;
wherein at least one of the first and second optional components are present in the aqueous and/or organic solutions, and
wherein the aliphatic polyamine monomers, amine reactive polysulfonyl monomers, polyamine monomers and amine reactive polyacyl monomers, are polymerized to form the sulfonyl compound residues, aliphatic amine compound residues, acyl compound residues and amine compound residues, respectively, as defined in claim 1.

25. The process of claim 24, wherein both the aqueous solution and the organic solution contain the optional component.

26. The process of claim 24, wherein the substrate is first contacted with the aqueous solution and then subsequently contacted with the organic solution.

27. The process of claim 24, wherein the substrate is first contacted with the organic solution and then subsequently contacted with the aqueous solution

28. A method of modifying a property of a reverse osmosis or nano-filtration membrane comprising a modified sulfonamide polymerix matrix on a substrate, the method comprising contacting the membrane with a polyol solvent and a surfactant for a time sufficient to modify the property of the membrane.

29. The method of claim 28, wherein the property of the membrane that is modified is the A value of the membrane or the salt selectivity of the membrane.

30. The method of claim 29, wherein the salt selectivity of the membrane is modified to increase the divalent to monovalent selectivity ratio.

31. The method of claim 28, wherein the polyol solvent is glycol, ethylene glycol, diethylene glycol, triethylene glycol or propylene glycol.

32. The method of claim 31, wherein the polyol solvent is glycol.

33. The method of claim 28, wherein the surfactant is an anionic surfactant.

34. The method of claim 33, wherein the anionic surfactant is sodium lauryl sulfate.

35. The method of claim 28, wherein the time sufficient to modify the property of the membrane is between 1 and 30 minutes.

36. The method of claim 35, wherein the time sufficient to modify the property of the membrane is about 20 minutes.

37. The method of claim 28, wherein the modified sulfonamide polymeric matrix is as defined in claim 1.

38. A combination comprising the modified sulfonamide polymer matrix of claim 1 coated on a support material.

39. A composite membrane comprising a modified sulfonamide polymer matrix according to claim 1 on a porous support material.

40. The compositie membrane of claim 39 that is a reverse osmosis (RO) or nano-filtration (NF) membrane.

41. The composite membrane of claim 40, wherein the polymeric matrix modifies at least one property of the RO or NF membrane.

42. The matrix of claim 41, wherein the property is the A value or the salt selectivity ratio of the membrane.

43. The modified sulfonamide polymer matrix of claim 1 which has been subjected to post-formation treatment with a polyol solvent and/or a surfactant.
